(19) United States
(12) Patent Application Publication
(10) Pub. No.: US 2019/0231042 A1
(43) Pub. Date: Aug. 1, 2019

(54) Method, System and Apparatus for Manufacturing a Wallet

(71) Applicant: Benjamin Garrek King, Pasadena, MD (US)

(72) Inventor: Benjamin Garrek King, Pasadena, MD (US)

(21) Appl. No.: 15/884,737

(22) Filed: Jan. 31, 2018

(51) Int. Cl. A45C 1/06; E05B 15/00

(52) U.S. Cl. CPC A45C 1/06; A45C 2001/067; E05B 15/008

(57) ABSTRACT

The invention is the method, system and apparatus provided for manufacturing a wallet that can be interactively designed and assembled/disassembled by the customer. There is a step for the user to communicate with the manufacturer by accessing the manufacturers portal through the designated communication channel(s); a step for selecting each part(s) desired, the material type for each part(s) selected and the color available for that material type and/or part(s); a step for the manufacturer to produce the selected part(s) in its material type and color using the latest manufacturing technology; a step for manufacturer to send the selected parts that are or can be assemble as, or into a wallet or send a part or set of part(s) for the user to assemble.

### CROSS-REFERENCE TO RELATED APPLICATION

Not Applicable

### STATEMENT REGARDING FEDERALLY SPONSORED RESEARCH OR DEVELOPMENT

Not Applicable

### REFERENCE TO A “SEQUENCE LISTING”

Not Applicable

### BACKGROUND OF THE INVENTION:

### 1. Field of the Invention

This disclosure relates generally to the fashion industry and particularly to the design and selection of a utilitarian fashion accessory. The invention is the method, system and apparatus provided for manufacturing a wallet that can be interactively designed and assembled/disassembled by the customer.

### 2. Description of the Related Art

The conventional way for buying a wallet is to visit a store and select the preferred ones from the displayed wallets on the shelves. Customers passively accept what the wallet manufacturers provide for the market. There is no interaction between the customer and wallet manufacturers. For some customers, who do not have time to visit the stores or because it is an inconvenience to go shopping, the conventional way for buying a wallet cannot meet their needs.

Furthermore, the typical wallet, in its produced form, is a complete unit with a set design and function(s). It is not designed to be disassembled and would become completely useless if disassembled by its user. Moreover, if it was capable of being reassembled, it would simply go back to its original design and function(s).

As the world has become more advanced, virtually every aspect of modern human existence has incorporated new technologies. With the improvement in technology, the manufacturing process of a wallet can become additionally personalized through the advent of the method that allows the design of the wallet by the customer.

The customer only has to communicate with the wallet manufacturer to have a preferable type of wallet which emulates the design and function that the customer deems appropriate, at anytime, because the wallet can be quickly disassembled and reassembled with interchangeable parts that change one or more of its design style and utilitarian functions.

The wallet is more personalized because the user has made personal decisions about the design of the wallet. This includes decisions as to the wallet's material types, colors and functions which give the user nearly limitless possibilities. In effect, the wallet becomes more capable, because its owner is also, in many respects, its creator and builder.

### BRIEF SUMMARY OF THE INVENTION

Because of these and other problems in the art, described herein, among other things, our present invention provides the method, system and apparatus for manufacturing a wallet that can be interactively designed and assembled/disassembled by the user. There is a step for the user to communicate with the manufacturer by accessing the manufacturers portal through the designated communication channel(s); a step for selecting each part(s) desired, the material type for each part(s) selected and the color available for that material type and/or part(s); a step for the manufacturer to produce the selected part(s) in its material type and color using the latest manufacturing technology; a step for manufacturer to send the selected parts that are or can be assemble as, or into a wallet or send a part or set of part(s) for the user to assemble.

Step 1, In an embodiment of the method, the wallet manufacturer provides a portal for the customer to communicate directly with the wallet manufacturer; this portal is 3D interactive and available online, as well as other types of communication.

Step 2, In an embodiment of the method, the wallet manufacturer provides a system which contains engineered designed parts available, that when assemble per the manufacturer's instructions, they construct a wallet; each part is interchangeable and has a utilitarian function when used with another part; combinations of said parts, when assembled, change the design and function of the wallet.

Part of step 2, in an embodiment of the method, the wallet contains a flexible Slide part that friction locks the contents inside the wallet. The system provides the parts that contain the necessary apparatus needed for the designed lock to function properly. The user can slide it from an open to closed position when the wallet is completely assembled and friction is used to lock the part in place and prevent the slide from opening without physical input from the user.

Part of step 2, in an embodiment of the method, the wallet manufacturer provides a system of material types available for each designed part; each part is independent of the other in regard to type of material.

Part of step 2, in an embodiment of the method, the wallet manufacturer provides a system of colors available for each material type for each designed part; each part is independent of the other in regard to color.

Step 3, In an embodiment of the method, the wallet manufacturer produces the selected parts from the system, for the customer, using technologies consistent with production requirements.

Step 4, In an embodiment of the method, the wallet can be disassembled and reassembled by the customer with more than or less than the original parts which can change the design and function of the wallet to meet the user's needs.

### BRIEF DESCRIPTION OF DRAWINGS

FIG. 1—Shows the method for obtaining a wallet.

FIG. 2—Shows the system which is comprised of the second, third and fourth embodiment of the method.

FIG. 3—Shows the slide friction lock and how the wallet system allows it to perform its function.

FIG. 4—Shows the fifth embodiment of the method, which is an exploded disassembled view of the wallet parts and just a few of many ways of how the system functions.

### DETAILED DESCRIPTION OF THE PREFERRED EMBODIMENTS

What follows is a detailed description of specific embodiment of the invention in which the invention may be practiced. The specific embodiment of the invention, which will be described herein, are presented for exemplification purposes, and not for limitation purposes. It should be understood that structural and/or logical modifications could be made by someone of ordinary skills in the art without departing from the scope of the present invention. Therefore, the scope of the present invention is defined only by the accompanying claims and their equivalents.

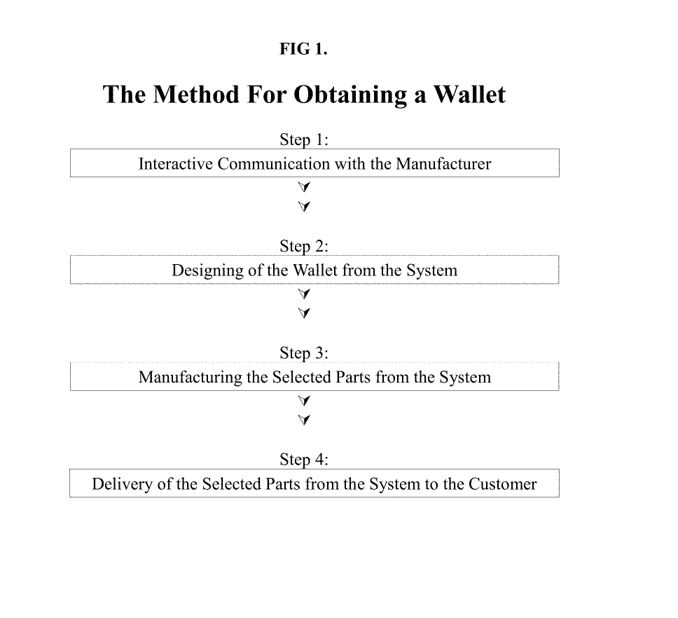

Referring to FIG. 1, the method of the present invention comprises

Step 1: interactive communication with the manufacturer;

Step 2: designing of the wallet from the system;

Step 3: manufacturing the selected parts from the system;

Step 4: delivery of the selected parts from the system to the customer;

The first embodiment of the method of the wallet manufacturer is to provide a communication portal to the customer for the intended purpose of designing a wallet. The main communication portal will be accessed via the internet through the manufacturer's website where a product configurator specific to the design and manufacturing of a wallet will exist. This product configurator is a 3D model and gives the customer the ability to interact with the system to add and subtract parts, choose the material type for each part and choose the color for each part based on the material type. Once the wallet is designed in whole or in part, by the customer, then the manufacturer produces the parts needed to assemble the customer's wallet within the confines of the system. This is just one of many communication portals for the customer.

The customer can design the wallet by themselves, the customer can have the design information from remote databases by using their own computers, or the customer can have the design information from near databases. In other words, the wallet design information can be obtained by the customer by any different ways that are possible, such as from the internet, from the magazines or even from other customer's designs.

The customers can conduct a telephone interview with the wallet manufacturer, or send a video to communicate with the wallet manufacturer, or conduct the communication with the wallet manufacturer via internet. The customer does not need to personally attend the wallet manufacturer's place.

Customers also discuss the information of the wallet with the wallet manufacturer by various ways to ensure that the needs of the customers are acknowledged by the wallet manufacturer. This is particularly important in the present invention because, in the conventional way to purchase wallets, customers cannot share their ideas or intentions with the wallet manufactures before the wallets are made. By the method of the present invention, the wallet manufacturer receives the customers' ideas or intentions before the parts in the system are made and this reduces manufacturers cost because the parts for the system they made are exactly what the customers want.

This is the perfect way that links the customers directly to the wallet manufacturer, the wallet manufacturer does not need to predict the trends of what the customers need, and with the system, the customers can control the materials, the colors and the functions they need.

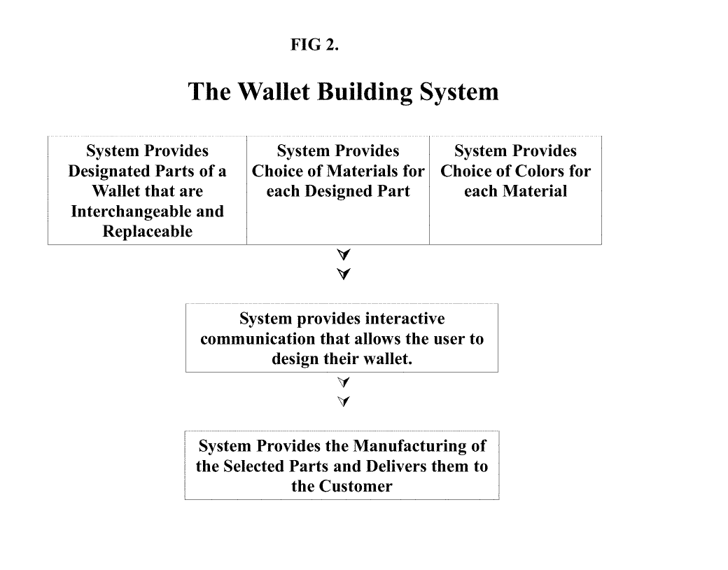

Referring to FIG. 2, the second, third and fourth embodiment of the method deals with the wallet manufacturer's system that provides the customer with a list of designated parts that have been engineered to fit together, when properly assembled in the confines of the system, to form a functioning wallet.

In an embodiment of the method, the system contains a unique mechanical part called a Slide Lock, that slides to friction lock the contents inside the wallet. The system provides the additional parts that contain the necessary groove needed for the designed Slide Lock to slide from an open to closed position when the wallet is completely assembled. When the two parts are assembled with the Slide Lock recessed inside each groove, the Slide Lock can be moved forward and backward along the curve. This curve creates enough friction that causes the Slide

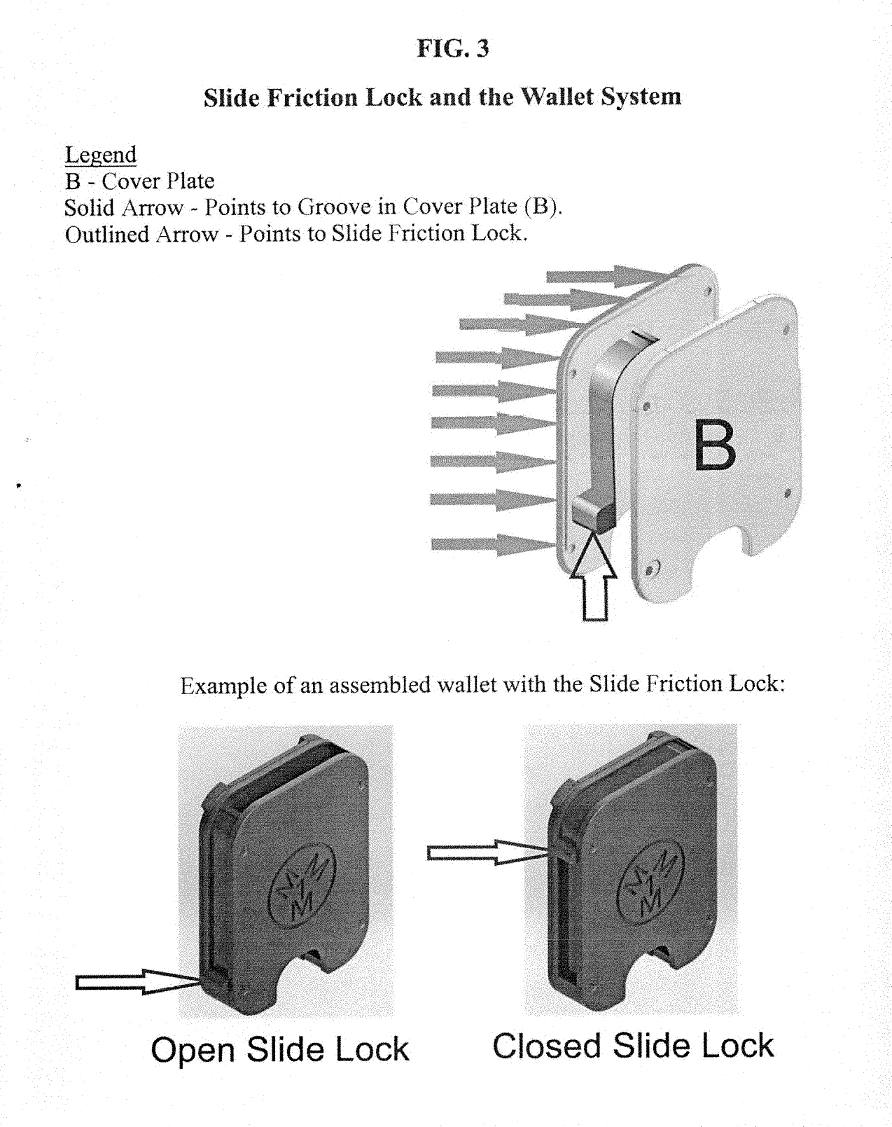

Lock to lock itself in place and prevents the Slide Lock from moving without physical input from the user. The groove in some of the additional parts of the system and the Slide Lock are completely illustrated in FIG. 3.

In the system, there is no one part that is required to form a functioning wallet. The material type option and color option for each part is independent of any other part. In the system, the wallet manufacturers determine the materials that are available based on production technology in the manufacturing process. Also, the wallet manufacturer determines the colors available for each particular material based on the vendor relationships and their availability to the wallet manufacturers.

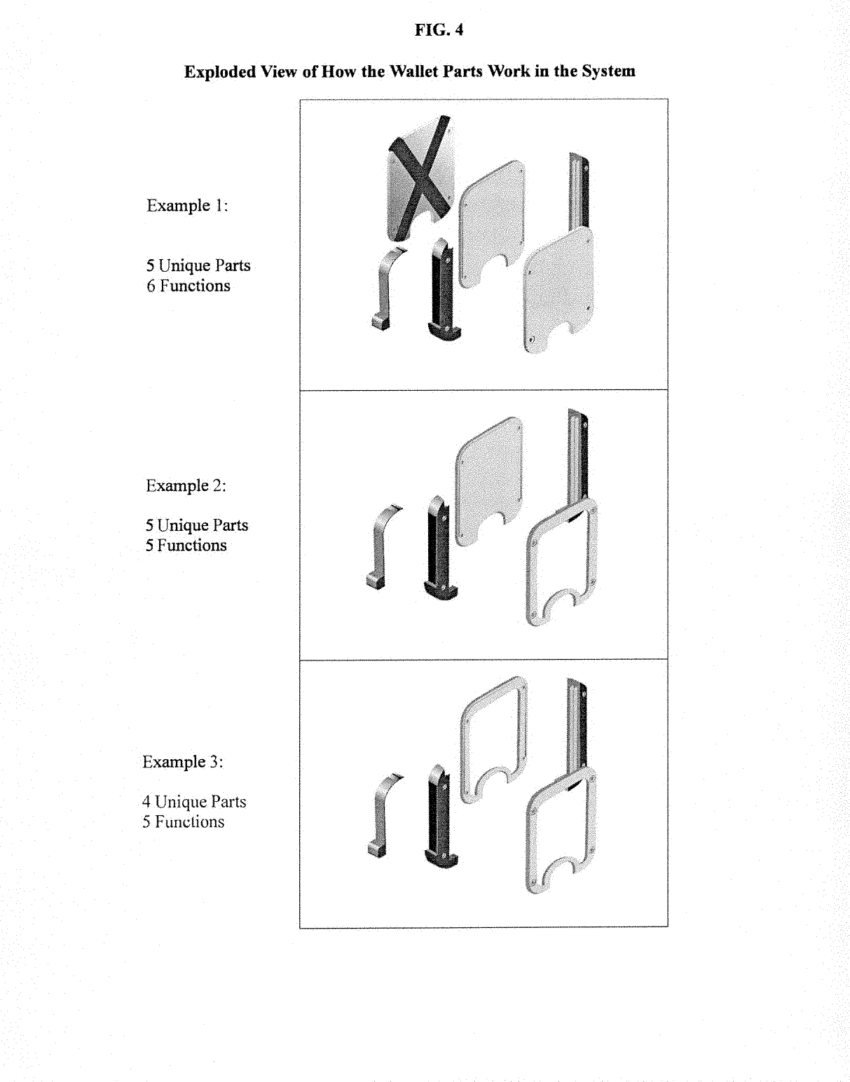

Referring to FIG. 4, the fifth embodiment of the method is the ability of creating a wallet from the assembly of a sum of interchangeable parts. Once assembled, based on the selected parts by the customer, the wallet will have one or more functions. However, at any time, the customer can add or remove parts from the wallet and change the number of functions it has and its overall design. The parts can be assembled in anyway the customer chooses. In the system, no specific part is required to make a wallet. Each major part, when used separate and independent of any other part has no utilitarian value.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the present invention. Therefore, the scope of this application is intended to cover alternate embodiments and/or equivalent variations of the specific embodiments illustrated and/or described herein. Hence, the scope of the present invention is defined only by the accompanying claims and their equivalents.

1. The method for obtaining a wallet, comprising:
Step 1: interactive communication with manufacturer;
Step 2: designing of the wallet from the system;
Step 3: manufacturing selected parts from the system;
Step 4: delivery of parts from the system to the customer;

2. The method as claimed in claim 1, wherein step 1 comprise interactive communication with the wallet manufacturer via internet.

3. The method as claimed in claim 1, wherein step 2 comprise the customer designs their wallet by themselves within the confines of the system.

4. The method for a system that provides designed parts with the necessary groove so that the wallet utilizes the designed flexible mechanical Slide Lock that friction locks in an open, semi open or closed position, thereby given access to, or securing the contents inside the wallet.

5. The method for a system comprising of a multitude of designed/designated parts in an array of materials and colors from which the customer can choose and then assemble together to create a wallet for their desired design and function(s).
